(19) United States
(12) Patent Application Publication
(10) Pub. No.: US 2011/0071903 A1
(43) Pub. Date: Mar. 24, 2011

(54) E-BUSINESS ADVERTISEMENT METHOD

(76) Inventor: Nankuei Lin, Taipei (TW)

(21) Appl. No.: 12/564,063

(22) Filed: Sep. 22, 2009

(51) Int. Cl. G06Q 30/00

(52) U.S. Cl. 705/14.54

(57) ABSTRACT

An e-business advertisement method includes providing an advertisement word on an advertisement items page of an advertisement server of an e-business platform; allowing a manager of the e-business platform to buy the advertisement word from a portal based on the advertisement word; interconnecting the Internet and the e-business platform; allowing a seller to link an item description page of the blog to the Internet; and linking the advertisement items page of the advertisement server of the e-business platform to the blog of the seller. The method can increase advertisement effect with cost being reduced.

### BACKGROUND OF THE INVENTION

1. Field of Invention

The invention relates to e-business and more particularly to an e-business advertisement method with improved characteristics.

2. Description of Related Art

A blog is a type of personal diary posted on the Internet. Most blogs consist of small, plentiful entries. Topics posted on blogs may vary widely.

Conventionally, e-business is impossible by means of blog. This is because only data such as pictures and documents are typically transmitted by a web server. High cost and technological difficulties make e-business using blog almost infeasible.

Currently, there are many websites providing online shopping. Conventionally, an item and a brief description thereof are shown on a web page. Hence, a would-be buyer may not know details of a desired item by simply viewing the web page. This may decrease interest of many would-be buyers. Many restrictions are also imposed on web pages provided by the online auction and shopping websites. This can further frustrate many would-be buyers.

A portal may charge a lot of money on an online seller if the seller want to buy an advertisement word therefrom. Further, links provided by the portal may be attacked maliciously by a hacker if computer security is not implemented. As a result, the desired effects of advertising are poor.

Thus, it is desirable to provide a novel e-business advertisement method in order to overcome the inadequacies of the prior art.

### SUMMARY OF THE INVENTION

It is therefore one object of the invention to provide an e-business advertisement method comprising providing an advertisement word on an advertisement items page of an advertisement server of an e-business platform; allowing a manager of the e-business platform to buy the advertisement word from a portal based on the advertisement word; interconnecting the Internet and the e-business platform; allowing a seller to link an item description page of the blog to the Internet; and linking the advertisement items page of the advertisement server of the e-business platform to the blog of the seller.

The above and other objects, features and advantages of the invention will become apparent from the following detailed description taken with the accompanying drawings.

### BRIEF DESCRIPTION OF THE DRAWINGS

FIG. 1 is a block diagram of an e-business advertisement system according to the invention;

FIG. 2 is a detailed block diagram of a portion of the e-business advertisement system;

FIG. 3 is a detailed block diagram of the advertisement server of FIG. 1;

FIG. 4 is a detailed block diagram of the advertisement items page of FIG. 1;

FIG. 5 is a detailed block diagram of another portion of the e-business advertisement system;

FIG. 6 is a detailed block diagram of the e-business platform of FIG. 1; and

FIG. 7 is a block diagram of a preferred embodiment of e-business advertisement system according to the invention.

### DETAILED DESCRIPTION OF THE INVENTION

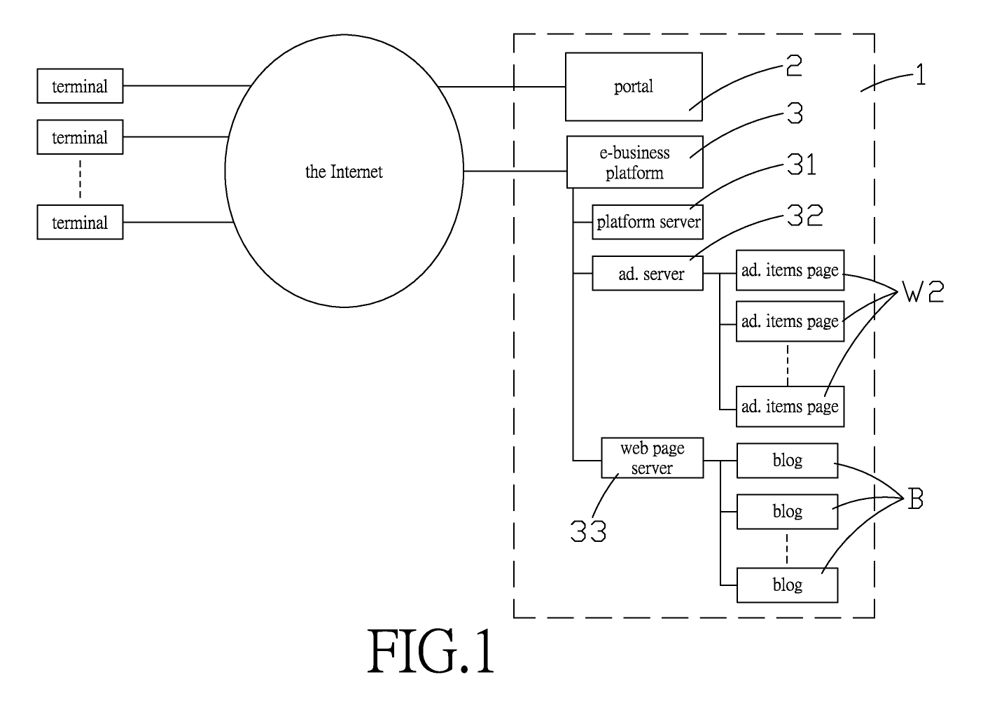

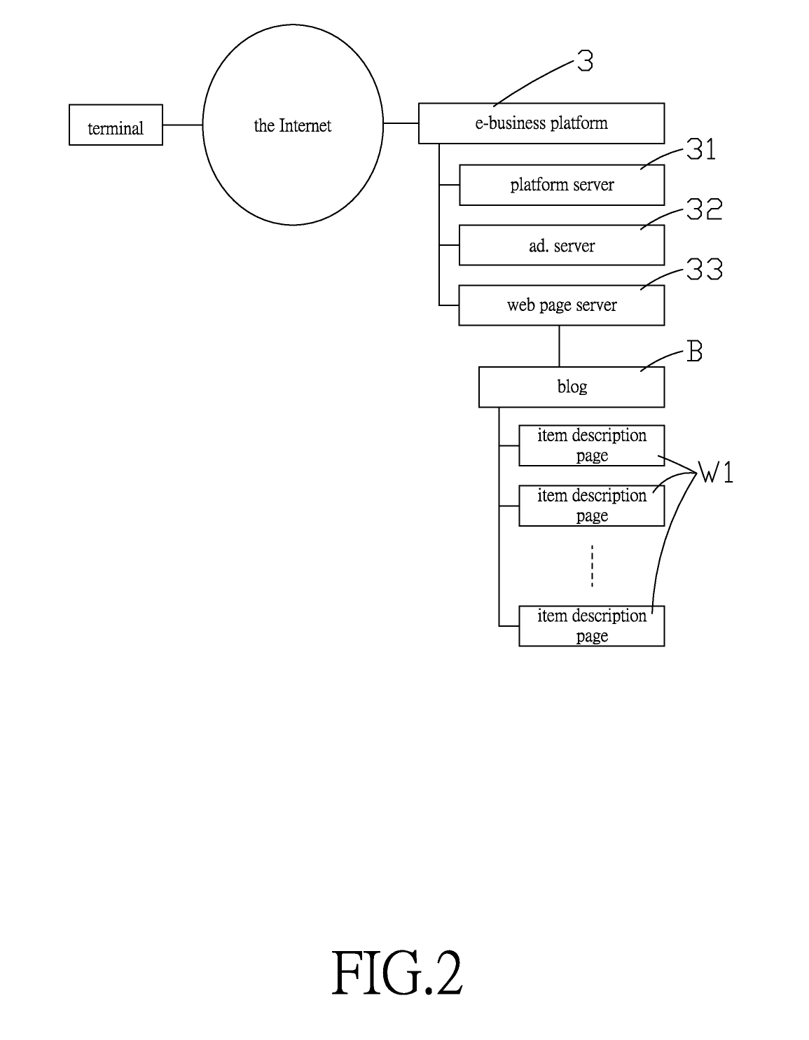

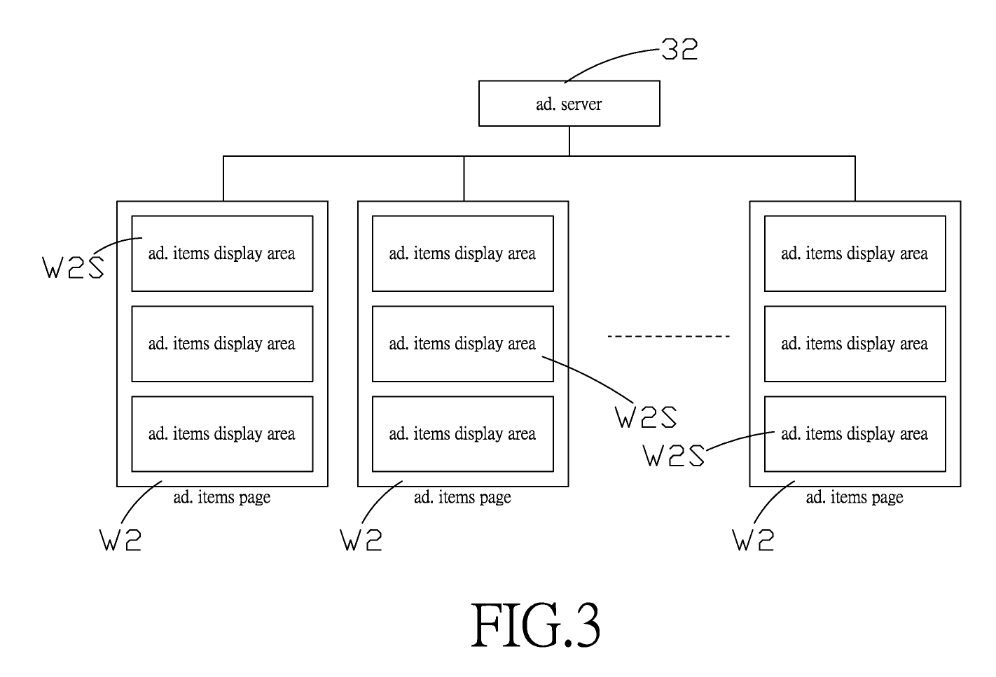

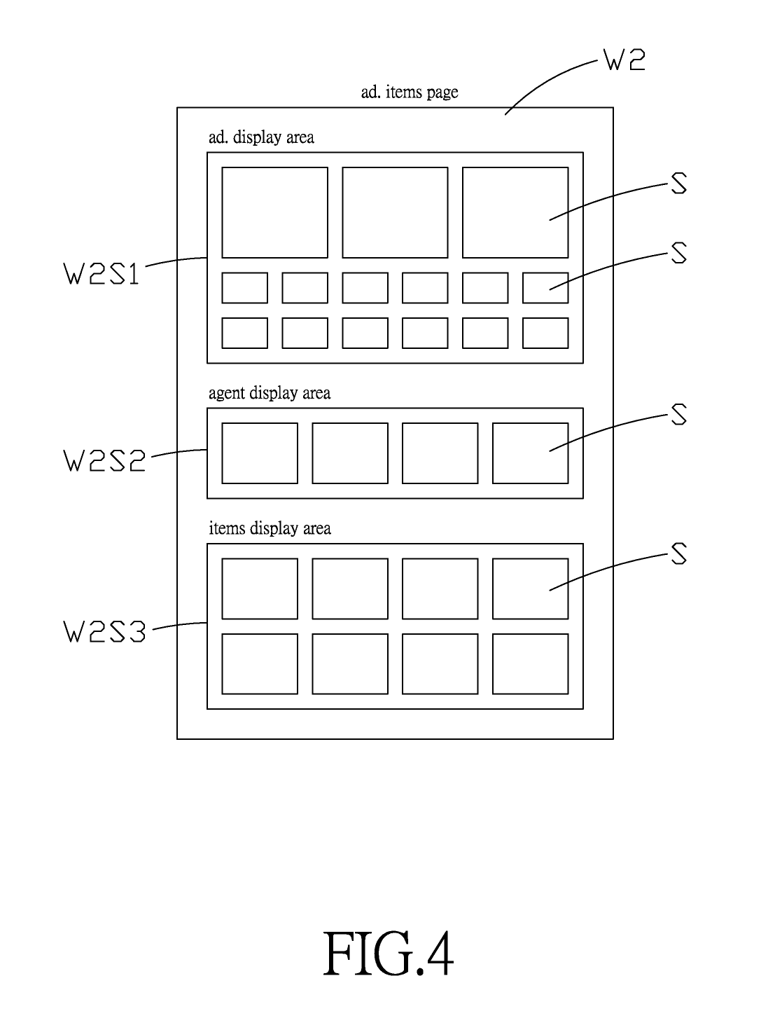

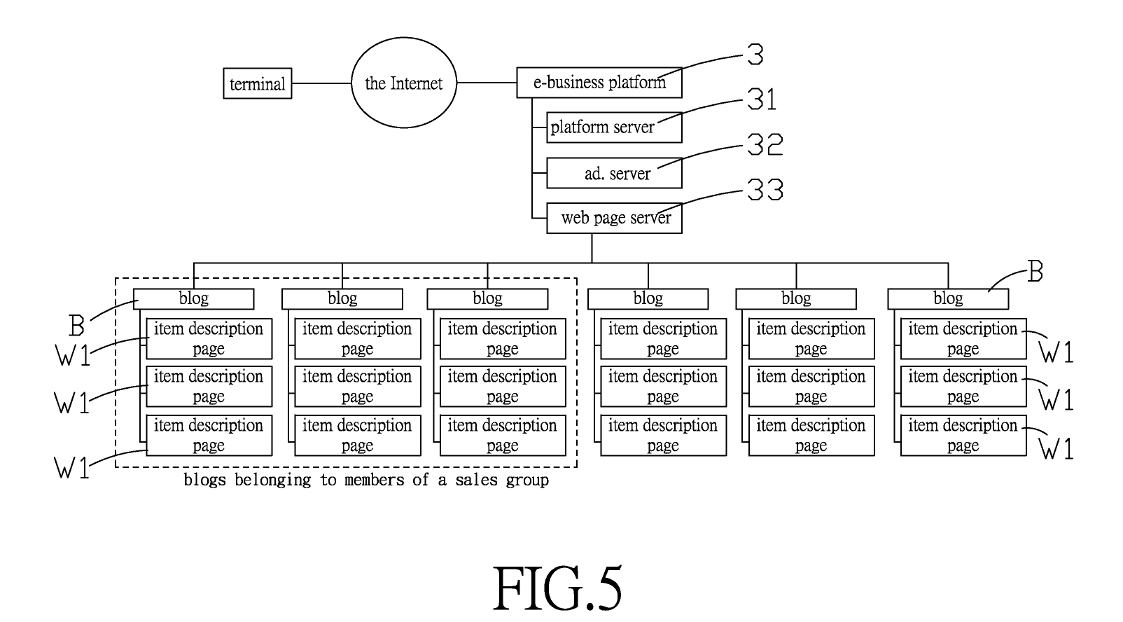

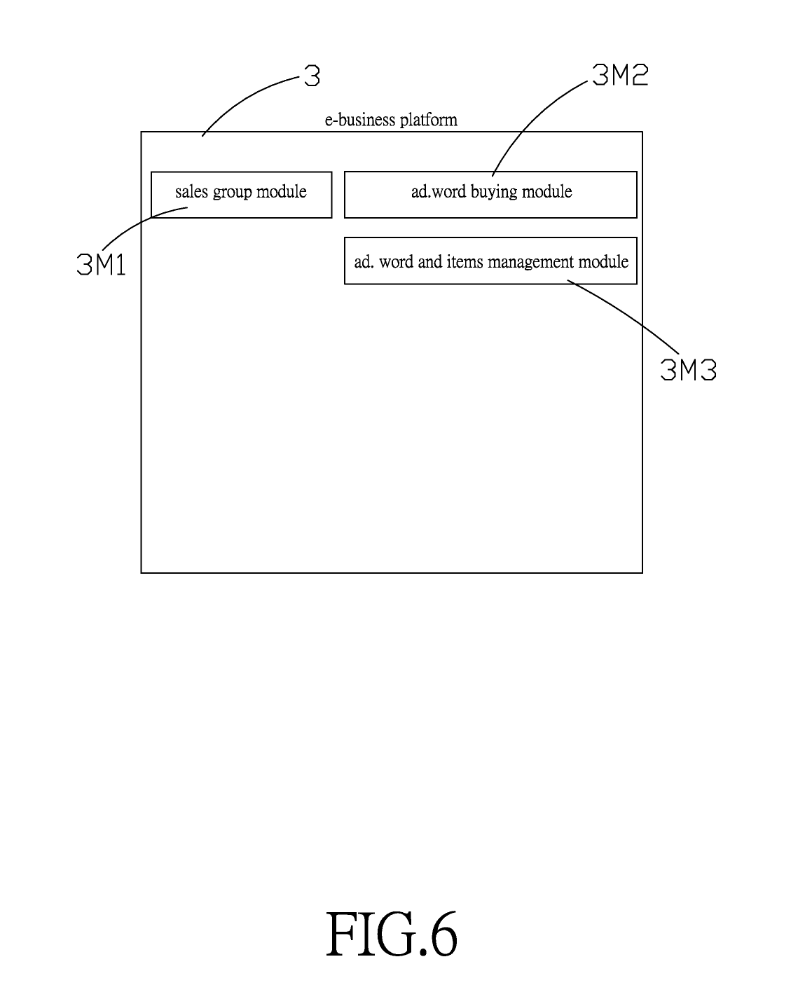

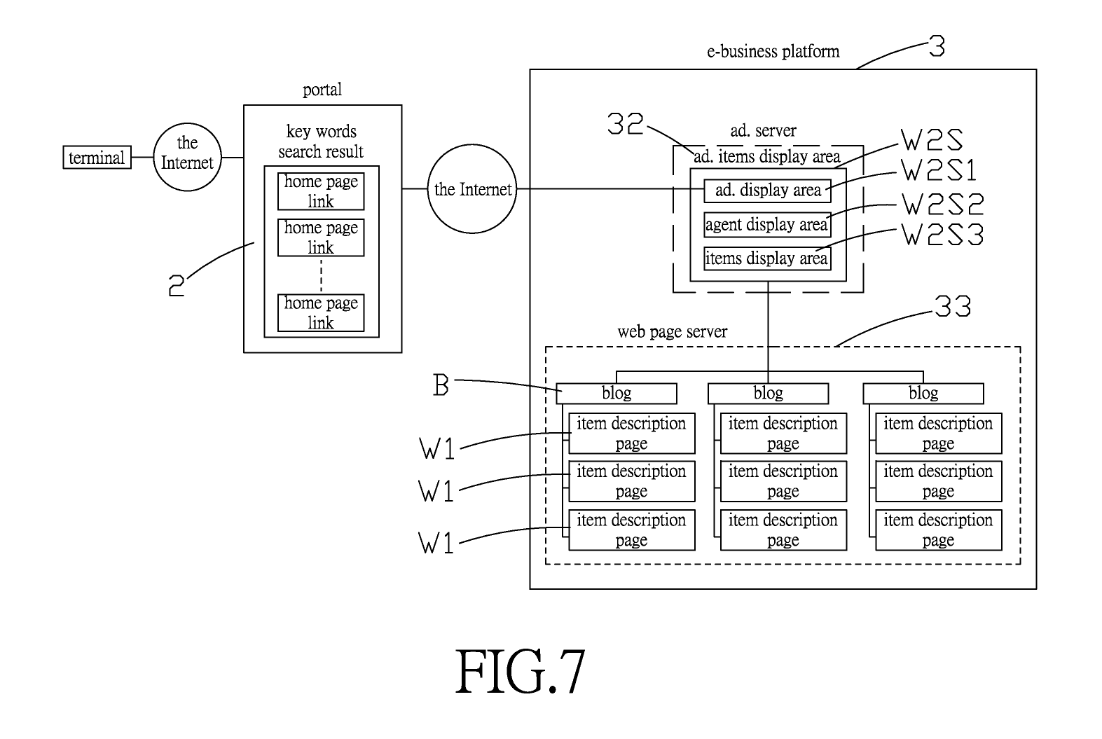

Referring to FIGS. 1 to 7, an e-business advertisement system 1 according to the invention is shown. The e-business advertisement system 1 comprises the following components as discussed in detail below.

A portal 2 is connected to the Internet. An e-business platform 3 is connected to the Internet. The e-business platform 3 comprises a platform server 31, an advertisement server 32, and a web page server 33. The advertisement server 32 comprises a plurality of advertisement items pages W2 including a plurality of advertisement items display areas W2S.

The platform server 31 is connected to the Internet via the e-business platform 3. The e-business platform 3 is connected to the portal 2 via the Internet which is in turn connected to a plurality of remote terminals for data communications. Moreover, the platform server 31, the advertisement server 32, and the web page server 33 are interconnected for data communications.

An e-business advertisement method for use in the e-business advertisement system 1 comprises the following steps:

Providing an advertisement word to each advertisement items page W2 of the advertisement server 32 of the e-business platform 3. A manager of the e-business platform 3 may buy the advertisement word from the portal 2 based on the advertisement word.

Comparing a search word typed on the portal 2 by a user with the advertisement word. A comparison result will be shown. A link to the advertisement items page W2 will be enabled if the comparison result is true. Thereafter, the user may click the advertisement items page W2 for linking.

Connecting a user of the remote terminal to the platform server 31 of the e-business platform 3 via the Internet. Typing personal data of the user in order to apply for a membership of the e-business platform 3. After obtaining the membership of the e-business platform 3, the user may register with the e-business platform 3 in order to use same as a seller.

Registering a seller with the e-business platform 3 so that the seller may obtain a membership of a sales agent of the e-business platform 3. Any sellers having the memberships of the e-business platform 3 are entitled as sales agents.

For registering a sales agent with the e-business platform 3 the platform server 31 of the e-business platform 3 is required to connect to the web page server 33 and web pages of a blog B of the seller are required to be created in the web page server 33. The seller is required to create an item description page W1 about each item to be sold on the blog B thereof. Details including pictures and detailed description of the item are also included in the item description page W1 so that a person may link same for retrieving information therefrom.

An advertisement word buying module 3M2 is provided on the e-business platform 3 in which only a sales agent has the right of using the advertisement word buying module 3M2.

The sales agent can click the advertisement word buying module 3M2 to start a procedure of buying an advertisement word. That is, buying the advertisement word from the e-business platform 3 in order to have the right of using the advertisement items display areas W2S of the advertisement items page W2 of the advertisement server 32 of the e-business platform 3 associated with the advertisement word.

A sales agent having bought the advertisement word is entitled to have a membership of the sales agent of the e-business platform 3. Any sales agents having the memberships of the e-business platform 3 are entitled as advertisement sales agents.

Providing an advertisement word and items management module 3M3 on the e-business platform 3. An advertisement sales agent has the right of using the advertisement word and items management module 3M3.

The advertisement sales agent can click the advertisement word and items management module 3M3 to start a procedure of providing an advertisement word. That is, replacing the advertisement word bought by the advertisement sales agent with a new advertisement word in order to have the right of using the advertisement items display areas W2S of the advertisement items page W2 of the advertisement server 32 of the e-business platform 3 associated with the new advertisement word. Alternatively, the advertisement sales agent can click the advertisement word and items management module 3M3 to start a procedure of providing an advertisement item. That is, linking pictures and description of the item description page W1 of the blog B belonging to the advertisement sales agent to a corresponding item description page W1 in order to provide the advertisement items display areas W2S on the advertisement items page W2 of the advertisement server 32 of the e-business platform 3 corresponding to the bought or replaced advertisement word.

Providing a sales group module 3M1 on the e-business platform 3 in which a sales agent has the right of using the sales group module 3M1.

A sales agent may create a sales group by setting the sales group module 3M1 in which the sales agent is entitled as a sales group manager. Other sales agents of the e-business platform 3 may join the same sales group by setting the sales group module 3M1 in which all sales agents of the sales group are members of the sales group of the e-business platform 3. The sales group manager has the right of using the item description page W1 of the blog B belonging to any member of the same sales group.

The sales group manager has the right of using the advertisement word buying module 3M2 on the e-business platform 3.

The sales group manager can click the advertisement word buying module 3M2 to start a procedure of buying an advertisement word. That is, buying the advertisement word from the e-business platform 3 in order to have the right of using the advertisement items display areas W2S of the advertisement items page W2 of the advertisement server 32 of the e-business platform 3 associated with the advertisement word.

A sales group manager having bought the advertisement word is given a title of the advertisement sales group manager of the e-business platform 3. Any sales group manager having the title of the advertisement sales group manager of the e-business platform 3 is entitled as an advertisement sales group manager.

The advertisement sales group manager has the right of using the advertisement word and items management module 3M3 on the e-business platform 3.

The advertisement sales group manager can click the advertisement word and items management module 3M3 to start a procedure of providing an advertisement word. That is, replacing the advertisement word bought by the advertisement sales group manager with a new advertisement word in order to have the right of using the advertisement items display areas W2S of the advertisement items page W2 of the advertisement server 32 of the e-business platform 3 associated with the new advertisement word. Alternatively, the advertisement sales group manager can click the advertisement word and items management module 3M3 to start a procedure of providing an advertisement item. That is, linking pictures and description of the item description page W1 of the blog B belonging to the sales group member of the same sales group to a corresponding item description page W1 in order to provide the advertisement items display areas W2S on the advertisement items page W2 of the advertisement server 32 of the e-business platform 3 corresponding to the bought or replaced advertisement word.

The advertisement items display area W2S on the advertisement items page W2 of the advertisement server 32 of the e-business platform 3 comprises an advertisement display area W2S1, an agent display area W2S2, and an items display area W2S3 in which each of the advertisement display area W2S1, the agent display area W2S2, and the items display area W2S3 has a plurality of display areas S.

As stated above, the sales agent or the sales group manager can click the advertisement word buying module 3M2 to start a procedure of buying an advertisement word to link to a home page of an advertisement word buying service provider so that the sales agent or the sales group manager may buy the advertisement word. In detail, the sales agent or the sales group manager is required to confirm both each bought advertisement word and the number of the bought advertisement words during the procedure.

The sales agent or the sales group manager can have the right of using the advertisement display area W2S1, the agent display area W2S2, and the items display area W2S3 on the advertisement items page W2 of the advertisement server 32 of the e-business platform 3 associated with a bought advertisement word. Moreover, after buying an advertisement word the sales agent or the sales group manager can have the right of uploading data about bought items to the display areas S of each of the advertisement display area W2S1, the agent display area W2S2, and the items display area W2S3.

As stated above, the advertisement sales agent can click the advertisement word and items management module 3M3 to start a procedure of providing an advertisement word in which pictures of the item description page of the blog B belonging to the advertisement sales agent and links thereof are displayed on the display areas S of advertisement display area W2S1 of the advertisement items page W2 of the advertisement server 32 of the e-business platform 3. Alternatively, the advertisement sales agent can click the advertisement word and items management module 3M3 to start a procedure of providing an advertisement item in which pictures of the item description page of the blog B belonging to the advertisement sales agent and links thereof are displayed on the display areas S of the agent display area W2S2 of the advertisement items page W2 of the advertisement server 32 of the e-business platform 3.

As stated above, the advertisement sales group manager can click the advertisement word and items management module 3M3 to start a procedure of providing an advertisement item in which pictures of the item description page of the blog B belonging to the members of the same sales group and links thereof are displayed on the display areas S of advertisement display area W2S1 of the advertisement items page W2 of the advertisement server 32 of the e-business platform 3. Alternatively, the advertisement sales group manager can click the advertisement word and items management module 3M3 to start a procedure of providing an advertisement item in which pictures of the item description page of the blog B belonging to the members of the same sales group and links thereof are displayed on the display areas S of the agent display area W2S2 of the advertisement items page W2 of the advertisement server 32 of the e-business platform 3.

To summarize, the invention provides an e-business advertisement method comprising providing an advertisement word on an advertisement items page of an advertisement server of an e-business platform; allowing a manager of the e-business platform to buy the advertisement word from a portal based on the advertisement word; interconnecting the Internet and the e-business platform; allowing a seller to link an item description page of a blog to the Internet; and linking the advertisement items page of the advertisement server of the e-business platform to the blog of the seller.

The e-business advertisement method of the invention has the benefits of greatly increasing advertisement effect, effectively providing and managing advertisement words and an item description page of a blog of an advertisement server of the e-business platform, allowing identical or similar items sold over the Internet by a seller to be grouped on an advertisement items page of the advertisement server of the e-business platform, allowing a manager of the e-business platform to buy advertisement words from the portal in order to greatly decrease the cost of buying advertisement words borne on a seller, increasing the advertisement effect of the items sold over the Internet, allowing a user to click a portal to link to the advertisement items page of the advertisement server of the e-business platform, and allowing the user to click the advertisement items page to link to a blog belonging to the seller after reviewing pictures and detailed description appeared on the advertisement items page.

While the invention herein disclosed has been described by means of specific embodiments, numerous modifications and variations could be made thereto by those skilled in the art without departing from the scope and spirit of the invention set forth in the claims.

What is claimed is:

1. An e-business advertisement method for use in an e-business advertisement system comprising a portal, an e-business platform including a platform server, an advertisement server including a plurality of advertisement items pages having a plurality of advertisement items display areas, and a web page server including a plurality of blogs wherein the portal and the e-business platform are interconnected via the Internet, and a plurality of terminals are connected to the Internet, the e-business advertisement method comprising:
(a) connecting a seller using the terminal to the Internet;
(b) providing an advertisement word to each of a plurality of advertisement items pages of the advertisement server;
(c) allowing a manager of the e-business platform to buy the advertisement word from the portal;
(d) comparing a search word typed on the portal by the seller with the advertisement word and generating a comparison result;
(e) if the comparison result is true, allowing the seller to link to the advertisement items page;
(f) further connecting the seller to the platform server via the e-business platform;
(g) registering the seller with the e-business platform so as to entitle the seller as a sales agent of the e-business platform;
(h) connecting the platform server to the web page server;
(i) creating an item description page about each item to be sold on the blog of the seller;
(j) allowing the sales agent to click an advertisement word buying module on the e-business platform to start a procedure of buying an advertisement word from the e-business platform in order to have the right of using the advertisement items display areas of the advertisement items page associated with the advertisement word;
(k) entitling the sales agent having bought the advertisement word as an advertisement sales agent;
(l) allowing the advertisement sales agent to click an advertisement word and items management module on the e-business platform to start a procedure of providing an advertisement word by replacing the advertisement word bought by the advertisement sales agent with a new advertisement word in order to have the right of using the advertisement items display areas associated with the new advertisement word;
(m) allowing the sales agent to create a sales group by setting a sales group module on the e-business platform and entitling the sales agent as a sales group manager;
(n) allowing the sales group manager to click the advertisement word buying module to start the procedure of buying an advertisement word from the e-business platform in order to have the right of using the advertisement items display areas of the advertisement items page associated with the advertisement word;
(o) entitling the sales group manager having bought the advertisement word as an advertisement sales group manager of the e-business platform;
(p) allowing the advertisement sales group manager to click the advertisement word and items management module to start the procedure of providing an advertisement word by replacing the advertisement word bought by the advertisement sales group manager with a new advertisement word in order to have the right of using the advertisement items display areas of the advertisement items page associated with the new advertisement word;
(q) configuring each of the advertisement items display areas as one including an advertisement display area, an agent display area, and an items display area wherein each of the advertisement display area, the agent display area, and the items display area has a plurality of display areas; and the sales agent or the sales group manager has the right of using the advertisement display area, the agent display area, and the items display area; and after buying the advertisement word the sales agent or the sales group manager has the right of uploading data about bought items to the display areas of each of the advertisement display area, the agent display area, and the items display area;
(r) allowing the advertisement sales agent to click the advertisement word and items management module to start the procedure of providing an advertisement word with pictures and description of the item description page of the blog belonging to the advertisement sales agent and links thereof being displayed on the display areas of the advertisement display area; and
(s) allowing the advertisement sales group manager to click the advertisement word and items management module to start a procedure of providing an advertisement item with the pictures and the description of the item description page of the blog belonging to a member of the same sales group and links thereof being displayed on the display areas of the advertisement display area.

2. The e-business advertisement method of claim 1, wherein step (l) is performed by allowing the advertisement sales agent to click the advertisement word and items management module to start the procedure of providing an advertisement item by linking the pictures of the item description page of the blog belonging to the advertisement sales agent to a corresponding item description page in order to provide the advertisement items display areas on the advertisement items page corresponding to the bought or replaced advertisement word.

3. The e-business advertisement method of claim 1, wherein step (p) is performed by allowing the advertisement sales group manager to click the advertisement word and items management module to start the procedure of providing an advertisement item by linking the pictures of the item description page of the blog belonging to a sales group member of the same sales group to a corresponding item description page.

4. The e-business advertisement method of claim 1, wherein step (r) is performed by allowing the advertisement sales agent to click the advertisement word and items management module to start the procedure of providing an advertisement item with the pictures and the description of the item description page of the blog belonging to the advertisement sales agent and links thereof being displayed on the display areas of the agent display area.

5. The e-business advertisement method of claim 1, wherein step (s) is performed by allowing the advertisement sales group manager to click the advertisement word and items management module to start the procedure of providing an advertisement item with the pictures and the description of the item description page of the blog belonging to a member of the same sales group and links thereof being displayed on the display areas of the agent display area.
